(19) United States
(12) Patent Application Publication
(10) Pub. No.: US 2006/0085230 A1
(43) Pub. Date: Apr. 20, 2006

(54) Methods and systems for healthcare assessment

(76) Inventors: Joel V. Brill, Scottsdale, AZ (US); Thomas O. Kaminsky, Scottsdale, AZ (US)

Correspondence Address: NATH & ASSOCIATES, PLLC, Sixth Floor, 1030 15th Street, N.W., Washington, DC, 20005, US

(21) Appl. No.: 11/121,174

(22) Filed: May 4, 2005

Related U.S. Application Data
(60) Provisional application No. 60/588,827, filed on Jul. 15, 2004.
(60) Provisional application No. 60/588,723, filed on Jul. 16, 2004.

(51) Int. Cl. G06Q 40/00

(52) U.S. Cl. 705/4; 705/2

(57) ABSTRACT

Certain embodiments provide methods and systems by which a predictive modeling provider may provide a client with predictive healthcare analysis. The predictive healthcare analysis may be used to assess whether a beneficiary is likely to develop conditions requiring healthcare. If such conditions are identified, intervention plans are developed and implemented to address the conditions and reduce healthcare costs. Certain embodiments provide method and systems by which an integrated benefits management organization may manage a client's healthcare program. A claim audit may be performed on healthcare claims of the client's beneficiaries. A claim repricing process may be used to discount the healthcare claims of the client's beneficiaries. In at least certain embodiments, the predictive modeling provider or integrated benefits management organization are motivated to maximize the reduction in the client's healthcare costs.

### BACKGROUND OF THE INVENTION

Many healthcare plans in the United States are employer funded or individually funded systems. In an employer-funded system, employees, and potentially their dependents (collectively, “beneficiaries”) receive health coverage through their employers. The employer, possibly in conjunction with an insurer, may pay all of the costs associated with the healthcare plan or the employee may also be required to contribute, such as by paying at least partial premiums, co-payments, deductibles, etc.

At the same time, costs associated with healthcare have risen rapidly over the past few decades. New medical technologies, prescription drugs, high compensation for providers, and lengthening life spans are reasons often cited for the high costs associated with the health industry. Managed care, such as health maintenance organizations (HMOs), and other cost-control methods emerged in an effort to contain such costs.

However, these cost-control means typically have not succeeded in containing the rapid rise of healthcare costs. As a result, some employers have begun taking a proactive role in cost containment. Some employers choose to minimize their expenses by at least partially self-insuring rather then purchasing costly group health insurance plans from third party insurance companies. In this regard, a self-insurer typically sets aside a certain amount of money from which it pays medical claims itself.

A problem with being self-insured, in general, is that the employer can be exposed to a great deal of risk. For example, critically ill beneficiaries can drain the company's medical insurance fund. This situation can leave the company open to liability from other employees whose medical claims cannot be paid as promised.

In order to guard against such risks, many self-insured employers purchase stop-loss insurance. Employers utilizing this type of arrangement are referred to as “partially self-insured.” Stop-loss insurance can protect the employer through various insurance policies.

For example, some insurance policies protect the employer against unusually large claims by any one beneficiary. This type of coverage commences expense payments once the employer has paid out a certain dollar amount, typically $10,000 or more. The stop-loss insurance company would then pay the remaining covered expenses of the beneficiary, up to the maximum amount allowed under the stop-loss policy.

Other stop-loss policies protect the employer against an unexpectedly high number of claims. With this type of coverage, the stop-loss carrier would pay claims after the aggregate claims paid by the employer reach a certain level. Although stop-loss insurance can reduce the risk an employer faces, it can be a significant added expense.

Because at least partially self-insured employers are directly paying at least part of their beneficiaries' claims, some employers employ people or retain outside parties to oversee aspects of their healthcare plan. Employers may hire their own staff to process and review healthcare data, such as bills, from sources such as hospitals, doctors, laboratories, imaging facilities, pharmacies, or other medical providers. However, unlike insurance companies that often have claim audit and claim repricing capabilities, an at least partially self-insured employer can experience significant difficulty managing these different tasks. Accordingly, employers may hire a service provider to review healthcare data, such as hiring a third party administrator (TPA) to process and review claims.

Similarly, employers may hire a Pharmacy Benefit Manager (PBM) to address drug claims. PBMs may restrict formularies, such as requiring substitution of generic drugs for name brand drugs or charging beneficiaries higher co-payments for brand named drugs. PBMs may also initiate disease management protocols.

Employers may utilize a Healthcare Management Provider (HMP). The HMP typically serves as an utilization or claim manager and may have a direct relationship with the beneficiary, medical provider, or the PBM. For example, after a medical provider sees a beneficiary and suggests one or more treatment options, the beneficiary's case may be reviewed by the HMP. If the HMP has suggestions for the beneficiary's treatment, the HMP may contact the medical provider or beneficiary to implement the suggestions. The HMP may, including in conjunction with a PBM, investigate and implement pharmaceutical solutions to various medical conditions. Both PBMs and HMPs help reduce costs by proposing medical solutions that are more effective or less costly, or that reduce the beneficiary's future healthcare needs.

Although hiring employees to manage healthcare costs, or contracting such functions to third parties, can reduce costs, these measures may not be entirely satisfactory. For example, there may not be a relationship between these various service providers, in which case disparate service providers may engage in redundant work. For example, each service provider may have to independently request data from medical providers and beneficiaries. This duplication of effort can reduce the amount of savings, since patient records will have to be sent to different locations. Furthermore, if inadequate communications exists, such as between medical providers, the PBM, and the HMP, different healthcare entities may reach different outcomes for a given medical problem, or engage in redundant treatments. This not only increases healthcare costs but also may be detrimental to the patient.

Rather than manage an at least partially self-insured healthcare plan, many employers choose to purchase group health insurance plans. This type of arrangement may leave all medical costs and claims up to the health insurance company. The employer is responsible only for the insurance premiums (at least part of which may be passed on to the employee). The insurance company may have its own staff to process claims. Such processing may include ensuring that the claim falls within the terms and conditions of the insurance policy, confirming that the service was required and performed, verifying the amount of the claim, and remitting payment to medical providers or pharmacies. Insurance companies may outsource any of these tasks.

As “for-profit” businesses, insurance companies often are not sufficiently motivated to reduce costs. One reason this is so is because cost increases often can be passed to the consumer. Accordingly, insurance companies may not provide the most effective means for implementing cost saving measures such as preventive health care techniques, including predictive modeling techniques, which may be cost-efficient in the long run. For example, insurance companies typically employ predictive modeling only in determining whether or not to provide insurance coverage or in conjunction with major disease packages.

As a result, in the United States, medical services are typically provided in a reactive manner. Typically, purchasers of health care, and those who pay for healthcare services (including insurance companies) look only at cost containment and at punitive methods of changing physician behavior. For example, some healthcare purchasers engage in techniques such as selective contracting (such as only covering claims if a patient sees a medical provider who has agreed to a certain cost structure) or utilization profiling (such as identifying physicians who often exceed an average cost for a particular condition).

In short, typical method of healthcare delivery, whether through insurance companies or at least partially self-insured employers, have often proven cumbersome and ineffective at adequately controlling costs or at improving healthcare by taking a proactive, preventative approach.

### BRIEF SUMMARY OF ASPECTS OF THE INVENTION

In at least one embodiment of the present invention, a predictive modeling provider (PMP) obtains healthcare data, which may be of one or more types, from one or more healthcare entities. For example, the PMP, or another entity hired by the PMP (collectively referred to herein as a PMP), may obtain healthcare data, including data on medical claims, which may be current or historical claims, from a third party administrator (TPA). Healthcare data may also be obtained from other sources, such as an employer (or “client”), a beneficiary (or “patient”), a medical service provider (such as a doctor or hospital), a pharmacy, a pharmacy benefits manager (PBM), insurance or underwriting companies, or a healthcare management provider (HMP), which may include claim auditors and care managers.

Once the PMP obtains the medical data, the medical data may be subjected to various analyses. In at least one embodiment, the analysis may be a predictive modeling analysis. The predictive modeling analysis may involve using predictive modeling to find conditions to which a beneficiary may be susceptible. Once these potential future conditions are identified, the future conditions, as well as existing conditions, can be analyzed to determine if there are ways of eliminating or reducing either the current or potential future healthcare costs associated with the conditions.

In one embodiment, if ways of potentially reducing a beneficiary's current or future healthcare costs are identified the PMP develops an intervention strategy. The intervention strategy may involve activities such as treating the beneficiary, monitoring the beneficiary, or helping the beneficiary with lifestyle changes. The PMP may then carry out the intervention strategy. For example, the PMP may work with the beneficiary, or a healthcare entity, to implement the intervention strategy.

In other embodiments, the PMP may work with an outside entity that may develop and carry out the intervention strategy. For instance, the PMP may interface with a PBM in order to manage a client's drug expenses. The PMP may provide predictive health data to the PBM. In certain embodiments, the PBM may provide a management protocol. In further embodiments, the PBM may implement the management protocol, such as implement a new pharmaceutical treatment or substituting medications.

In certain embodiments, the intervention strategy may be developed by one healthcare entity while another healthcare entity may carry out the intervention strategy. For example, in one embodiment a patient sees a medical provider and the medical provider suggests various treatment options. The case may then be reviewed by an HMP, including data they receive from the PMP, as part of utilization review, pre-certification review, concurrent review, or case management. The HMP may develop an intervention strategy. The PMP may then implement the intervention strategy, or direct another healthcare entity to do so.

In another embodiment, the PMP and PBM may cooperate in developing and carrying out an intervention plan. For example, the PMP may develop a strategy that may be implemented by the PBM. In one embodiment, the PBM uses the strategy to determine which pharmaceutical treatment might be the most appropriate and cost efficient treatment for a beneficiary. In other embodiments, the PMP may work directly with a pharmacy to implement the strategy.

In further embodiments, the intervention strategy may be carried out in a cooperative manner by the PMP and a medical provider. For example, the PMP may use predictive modeling to identify physicians with high risk members who are not following guidelines. The PMP may then work with these physicians one-on-one to deliver appropriate health care, such as making sure the beneficiary's treatment meets appropriate standards.

In additional embodiments, the PMP may maintain a database that may include predictive modeling data and healthcare data, including historical healthcare data. The database may also contain beneficiary information such as a beneficiary profile, a risk profile, or an impact profile. The PMP can allow healthcare entities, such as medical providers, to access the database to obtain healthcare data on relevant beneficiaries. The ability of medical providers, and other healthcare entities, to access a cumulative database of beneficiary data may improve the beneficiaries' health care and lead to lower healthcare costs. For example, access to complete and timely information may lead to more rapid or effective treatment, which may reduce the amount spent on treatment by eliminating or reducing the severity of a condition. Access to such information may also prevent unnecessary, conflicting, or duplicative treatments.

Employment of various embodiments of the present invention described above may allow substantial savings in healthcare costs to be realized. For example, a beneficiary's health risk may be quantitatively or qualitatively identified by analyzing various contributing factors, such as genetic or environmental factors, that might predispose the beneficiary to developing a condition. An intervention strategy, such as beneficiary monitoring or behavior management (such as diet alteration), may reduce or eliminate the risk of the beneficiary developing the condition. Similarly, review of present conditions may reveal deficiencies in the beneficiary's current course of treatment. Healthcare costs may be reduced, and the beneficiary's health improved, by remedying treatment deficiencies.

The proactive healthcare management strategies of at least some embodiments of the present invention may result in cost saving by reducing or eliminating the need for expensive healthcare at a future date, or by reducing the cost of current treatments. These cost savings may benefit many players in the healthcare industry. Beneficiaries may benefit by having more effective and timely care. For example, if new treatments for a condition are found, beneficiaries who might benefit from the new treatment may be identified. Beneficiaries may benefit from reduced out of pocket expenses, co-payments, and insurance premiums.

Clients, such as employers, may benefit through reduced spending on healthcare, such as when beneficiaries are able to avert or reduce the severity of a medical condition. Insurance companies may benefit from reduced spending on healthcare by being more competitive and more profitable. Insurance companies may be able to pass some of this saving on to the client, such as by reducing premiums. Because of the availability of complete, current, and accurate healthcare information, beneficiaries' risk may be better estimated, which may allow clients to more accurately plan for expenses and insurance companies to more precisely set premiums.

Similarly, a PBM may provide discounts to the client, such as because predictive health care may reduce the need for medications, resulting in a lower cost to the pharmacy benefits manager. A similar relationship may exist with the TPA.

Because at least certain embodiments of the present invention result in greater information sharing and coordination between players in the healthcare industry, wasteful and duplicative treatment can be better avoided while ensuring the highest level of care is provided to beneficiaries. Medical providers benefit may benefit by having greater and easier access to patient data and assistance with developing treatment plans.

In certain embodiments, the PMP is run as a business, which may be part of or independent from other healthcare entities (such as the TPA, the medical provider, etc.). The PMP may charge a fee for providing various services, such as for providing predictive healthcare analysis, developing intervention strategies, implementing intervention strategies, creating a healthcare database, maintaining the healthcare database, and providing access to the healthcare database. Moreover, the PMP may charge for any fees charged by other healthcare entities (such as a TPA, a medical provider, etc.) for medical records. The PMP may charge the client, or a healthcare entity, a setup fee for interfacing with the client or healthcare provider's datastream. In at least one embodiment, the PMP provides its services to a plurality of clients on an on-going basis.

In certain embodiments, the present invention provides a method of managing healthcare services. In some embodiments, the method of managing healthcare services is part of a business. According to at least one embodiment, an Integrated Benefits Management Organization (IBMO) carries out the method of managing healthcare services and assists a client in managing a healthcare program. In further embodiments, the client is at least partially self-insured. By at least partially self insured, it is meant that the client sets aside money and directly pays at least a portion of their beneficiaries' claims.

Managing the healthcare program may include integrating or establishing relationships between one or more healthcare entities, including the client, beneficiaries, a pharmacy, a PBM, a HMP, a medical provider, a TPA, and a stop-loss insurance carrier. Integration or coordination of the various healthcare industries may result in a more efficient, more effective, and less costly healthcare program.

Certain embodiments of the present invention provide systems and methods for analyzing healthcare data and then using the results of the analysis to address healthcare issues. Healthcare data may come from a number of sources, such as any of the healthcare entities, and may be historical, current, or predicted healthcare data. Although the client may employ a variety of healthcare entities, and may change healthcare entities over time, data from these multiple sources can be analyzed and integrated. In at least one embodiment, healthcare data is maintained in a database that may be independent from the healthcare entities, and may be maintained by the IBMO. As such, the data can follow along with the client, should the client elect to migrate to a new healthcare entity providing a healthcare service. For example, the client may switch to a different TPA, PBM, or stop-loss insurer. Thus, rather than becoming an asset of a particular healthcare entity, certain embodiments of the present invention place the client in control of their own data. In addition, a central database of healthcare data can aid healthcare entities, such as medical providers, in ensuring that complete, effective, and cost-effective care is provided to beneficiaries.

In at least one embodiment, the IBMO is a PMP and may operate as discussed above. In further embodiments, the IBMO provides alternate or additional services. For example, the IBMO may receive healthcare data from one or more healthcare entities. The healthcare data may include claims data for a plurality of healthcare claims. The IBMO may audit the claims data to determine if any healthcare claims were unnecessary, fraudulent, were not performed, or were of higher than average cost. In certain embodiments, claims over a certain threshold trigger an audit. This audit may be performed prior to applying any discounts, such a discount for using a physician in a particular network. In certain embodiments, the audit is a detailed line-by-line audit. In at least one embodiment, the IBMO retains as a fee a portion of any savings resulting from billing errors revealed in the audit process. In this way, the IBMO may be provided with an incentive to reduce the client's healthcare costs. In at least one embodiment, the IBMO charges the client a periodic fee for providing the claim audit process, which may be correlated to the numbers of beneficiaries the IBMO is managing.

The IBMO may also determine whether appropriate discounts were applied to healthcare claims, or try to negotiate discounts, a process sometimes referred to as claim repricing or claim adjustment. For example, the IBMO may determine whether the claim involved medical providers in the beneficiary's primary network. If not, the IBMO may see if a secondary network is available. A secondary network may be a medical provider network that the medical provider is a member of, but the beneficiary is not a member of. The IBMO may work with the medical provider to obtain the secondary network rates for the beneficiary's claim. If no secondary network is available, the IBMO may attempt to negotiate a lower rate, such as by offering faster payment in return for reducing the claim. In cases where the IBMO obtains a lower rate, such as by using a secondary network or rate negotiation, the IBMO may charge the client a percentage of the recovered cost savings as a fee for providing the claim repricing service. In this way, the IBMO is incentivized to lower the client's healthcare costs. In at least one embodiment, the IBMO charges the client a periodic fee for providing the claim repricing process, which may be correlated to the numbers of beneficiaries the IBMO is managing.

In certain embodiments, the IBMO provides the services directly to the client. In other embodiments, the IBMO uses one or more third parties to carry out the IBMO's tasks. For example, the IBMO may gather the medical data, transmit the medical data to a third party which performs predictive health analysis, transfer the predictive health analysis to a care manager to develop an intervention strategy, and communicate the intervention strategy to the beneficiary, the client, or the medical provider. In at least one embodiment, the interface between each healthcare entity involves personal contact between each entity. In other embodiments, the interface between each healthcare industry is automated.

In certain embodiments, the client may be provided with one or more reports. In one embodiment, a report may be generated and provided to the client for each claim made by a beneficiary. The report may provide information such as the beneficiary's identity, the healthcare entity providing the healthcare service, the correct billable charges, and the allocation of responsibility for paying the correct billable charges. Any discrepancies may also be noted on the report, such as any difference between the charges billed by the provider and the correct billable charge, or an amount saved by performing the claim repricing process.

In obtaining and analyzing medical claims and information, the IBMO may generate a variety of data that may be of use to one or more healthcare entities. This information may be provided to such entities for free, for a charge, or as part of the IBMO's services. For example, as claims are analyzed, various risk factors and costs may be identified. This data can be provided to insurers who can then more accurately price their products to account for a risk. Similarly, profiles can be developed for various healthcare providers and treatments, which may help auditing and fraud analysis and claim adjustment, such as by identifying healthcare providers who routinely perform unnecessary treatments or submit higher than average charges.

Furthermore, as more medical data is obtained and analyzed, predictive health services may be improved. For example, predictive algorithms can be updated to more accurately reflect real world conditions. As these algorithms become more accurate, more risk factors can be identified and intervention strategies can be indicated at earlier times, potentially resulting in even further cost savings.

One or more of the previously discussed embodiments may find use in areas other than healthcare. For example, predictive modeling services and management services may be applied in workman's compensation systems or in nursing home care. Additionally, the predictive modeling services and management services may be applied to animal health, for example in reducing the healthcare costs of thoroughbred horses or champion dogs.

It can thus be seen that there are many aspects of the present invention, including many other additional or alternative features that will become apparent as this specification proceeds. It is therefore understood that the scope of the invention is to be determined by the claims as issued and not by whether the claimed subject matter solves any particular problem or all of them, provides any particular features or all of them, or meets any particular objective or group of objectives set forth in the Brief Summary above.

### BRIEF DESCRIPTION OF THE DRAWINGS

FIG. 1 is a schematic diagram illustrating an embodiment of relationships that may be formed between a client, beneficiaries, a predictive modeling provider, and various other healthcare entities.

FIG. 2 is a schematic diagram illustrating an embodiment of healthcare data collection by the predictive modeling provider of FIG. 1.

FIG. 3 is a flowchart illustrating a method by which the predictive modeling provider of FIG. 1 may perform a predictive healthcare analysis and develop an intervention plan.

FIG. 4 is a schematic diagram illustrating an embodiment of how the predictive modeling provider of FIG. 1 may gather healthcare data in order to perform a predictive healthcare analysis.

FIG. 5 is a schematic diagram illustrating an embodiment of how the predictive modeling provider, beneficiary, and medical service provider of FIG. 1 may implement an intervention plan developed using the process of FIG. 3.

FIG. 6 is a schematic diagram illustrating an embodiment of how the predictive modeling provider and other healthcare entities of FIG. 1 may work together to implement an intervention plan.

FIG. 7 is a schematic diagram illustrating an embodiment of how a first healthcare entity may develop an intervention strategy and a second healthcare entity may implement the intervention strategy.

FIG. 8 is a schematic diagram illustrating an embodiment of how the predictive modeling provider of FIG. 1 and another healthcare entity may cooperate to develop and carry out an intervention plan.

FIG. 9 is a schematic diagram illustrating an embodiment of how the predictive modeling provider of FIG. 1 and a medical service provider may cooperate to improve the services provided to healthcare beneficiaries.

FIG. 10 is a schematic diagram illustrating an embodiment of how the predictive modeling provider of FIG. 1 may create a healthcare database that may be accessed by one or more healthcare entities.

FIG. 11 is a schematic diagram illustrating embodiments of various fees the predictive modeling provider of FIG. 1 may charge.

FIG. 12 is a schematic diagram illustrating an embodiment of how an integrated benefits management organization may work with one or more healthcare entities to provide various healthcare services to a client.

FIG. 13 is a schematic diagram illustrating an embodiment of various services the integrated benefits management organization of FIG. 12 may provide to one or more clients.

FIG. 14 is a schematic diagram illustrating an embodiment of how the integrated benefits management organization of FIG. 12 may obtain healthcare data.

FIG. 15 is a flowchart illustrating an embodiment of a claim audit process that may be performed by the integrated benefits management organization of FIG. 12.

FIG. 16 is a flowchart illustrating an embodiment of a claim repricing process that may be performed by the integrated benefits management organization of FIG. 12.

FIG. 17 is a schematic diagram summarizing an embodiment of various ways the integrated benefits management organization of FIG. 12 may provide services to its clients.

FIG. 18 is a schematic diagram illustrating embodiment of various reports that may be generated in sent in the healthcare system depicted in FIG. 12.

FIG. 19 is a schematic diagram illustrating embodiments of fees that may be charged by the integrated benefits management organization of FIG. 12.

### DETAILED DESCRIPTION OF PREFERRED EMBODIMENTS

Predictive Modeling Provider

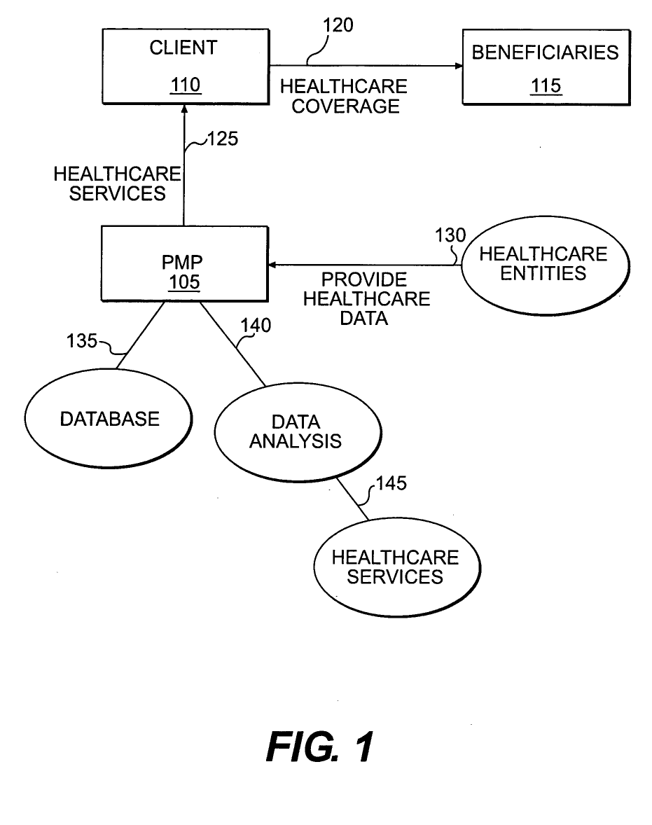

The flow chart depicted in FIG. 1 shows a set of relationships by which a predictive modeling provider (PMP) 105, or another entity hired by the PMP 105 (collectively referred to herein as a “PMP”), may perform one or more services for a client 110. The client 110 may be an employer that provides health care coverage or compensation, in step 120, to a beneficiary 115. Beneficiaries 115 include one or more employees, their spouses, and their dependants. In an alternative embodiment, the client 110 is an insurance company that pays for all or a certain percentage of the beneficiary's 115 health care expenses. In this alternative embodiment, the beneficiaries 115 include members of, or purchasers of, the health coverage the insurance company provides.

The client 110 hires the PMP 105 in step 125 to perform one or more services. The PMP 105 may be hired to keep track of the health care services provided to one or more beneficiaries 115. The PMP 105 is also hired to obtain or analyze data regarding the health of one or more beneficiaries 115.

For example, in step 130, the PMP 105 obtains data from various entities. In at least certain embodiments, the data may be obtained in any format and the PMP 105 utilizes the data in the format provided or converts the data to a suitable format. After the data is obtained, the PMP 105 may use the data in various ways. For instance, in step 135, the PMP 105 creates a database which contains information regarding the health of, and healthcare services provided to, one or more beneficiaries 115. The PMP 105 may allow various entities to use the database.

The PMP 105 subjects the data in the database to one or more analyses. For example, the PMP performs a predictive health analysis in step 140. In step 145, the PMP 105 uses the results of the analyses is various ways. For example, the results of the predictive health analysis may be used to identify medical conditions to which a beneficiary 115 is susceptible and to formulate intervention strategies to address such conditions.

Data Acquisition by the Predictive Modeling Provider

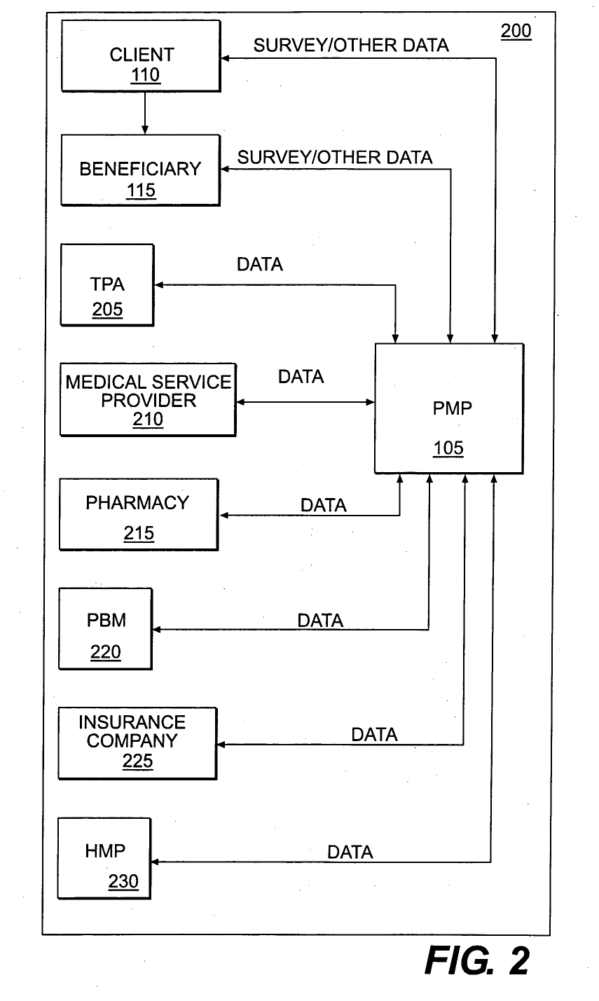

In performing its services to the client 115, the PMP 105 often has various relationships with other entities. One possible set of relationships is shown in FIG. 2. As shown, the PMP 105 obtains healthcare data from one or more health care entities. The healthcare data is of various types and is obtained by the PMP 105 through physical, telephonic, or electronic means.

Two healthcare entities from whom the PMP 105 may obtain healthcare data are the client 110 and one or more beneficiaries 115. In one embodiment, the PMP 105 distributes a questionnaire or survey to be completed by the beneficiary 115 or the client 110. Such a survey includes various inquiries, such as questions about the beneficiary's 115 health, familial medical history, and lifestyle. The survey may seek other information, such as the current healthcare costs that the client 110 incurs by providing health coverage to the beneficiary 115. Upon the completion of the questionnaire or survey, the beneficiary 115 or the client 110 returns the information to the PMP 105. The PMP 105 could also ask the beneficiary 115 to submit to various screening tests, including obtaining genetic data for genetic screening.

The PMP 105 may collect data or information about a beneficiary 115 from a third party administrator (TPA) 205. The TPA 205 is typically hired by the client 110 to process and review beneficiaries' 115 claims. Accordingly, the TPA 205 often will have data related to the beneficiaries 115, such as information with respect to claims and costs for various services provided to the beneficiaries 115.

The PMP 105 may obtain data from medical service providers 210 or pharmacies 215. Medical service providers 210 include entities that provide medical services to beneficiaries 115, such as physicians, hospitals, nurses, laboratories, and x-ray or imaging providers. These medical service providers 210 typically have healthcare data, such as information regarding the beneficiary's 115 health or services that were provided to the beneficiary 115. Similarly, a pharmacy 215 typically has healthcare data such as information regarding a beneficiary's 115 drug treatments and costs associated with such treatments.

The PMP 105 may obtain data from a pharmacy benefit manager (PBM) 220. The PBM 220 is utilized by a client 110 to manage drug claims. In at least one embodiment, the PBM 220 restricts formularies, such as by excluding certain drugs. The PBM 220 often requires substitution of generic drugs for brand name drugs or charges beneficiaries 115 higher co-payments for brand named drugs. The PBM 220 typically has information related to drug costs and disease management protocols.

The PMP 105 may also obtain data from an insurance company 225. The insurance company 225 is sometimes employed by a client 110 to manage, reduce, or pay healthcare costs. For example a client 110, such as an employer, often purchases a group health insurance plan from an insurance company 225 to provide health coverage to its employees. In at least one embodiment, the insurance company 225 is a stop-loss insurance company that pays at least a portion of the medical costs of a partially self-insured client 110. For example, while a client 110 pays for a beneficiary's 115 health care costs out-of-pocket, the client 110 purchases stop-loss insurance to protect against unusually large claims by any beneficiary 115 or against aggregate claims by all beneficiaries 115 that exceed a certain amount. Hence, the insurance company 225 usually has information regarding healthcare services provided to a beneficiary 115, a beneficiary's 115 medical history and their various associated costs.

In a further embodiment, the PMP 105 obtains data from a healthcare management provider (HMP) 230. A HMP 230 is often used by entities, such as insurance companies 225 and clients 110, to manage healthcare services that are provided to a beneficiary 115. The HMP 230 often functions as a care manager. As a care manager, the HMP 230 typically works directly with other healthcare entities to manage the beneficiary's 115 healthcare services. In a yet further embodiment, the HMP 230 has a direct relationship with a medical service provider 210 for various reasons, such as to determine appropriate treatment options for a beneficiary 115. In turn, in a least certain embodiments the HMP 230 has a direct relationship with a PBM 220 for various purposes, such as to ascertain appropriate drug treatments for a beneficiary 115. The PBM 220 may have a direct relationship with a beneficiary 115, such as by working with the beneficiary 115 to implement various treatments for a given condition. Therefore, the PMP 105 can gain knowledge about the beneficiary's 115 healthcare needs and treatments by gathering information from the HMP 230.

Data Analysis

Once the data is obtained by the PMP 105, the data is subjected to one or more analyses. In one embodiment, a predictive modeling analysis is conducted. Predictive modeling analysis is often used to identify beneficiaries 115 who are most in need of additional resources or to find conditions to which a beneficiary 115 is susceptible.

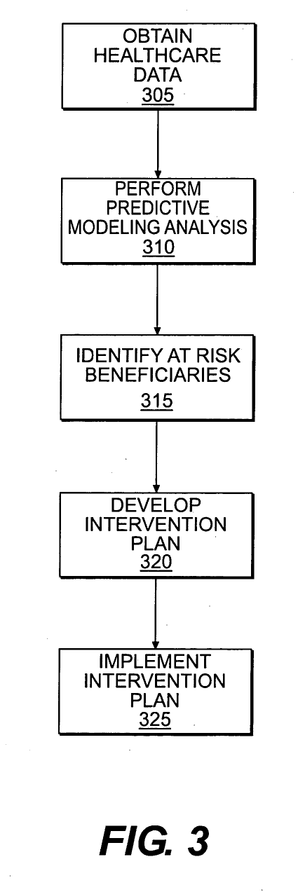

There are various approaches to how predictive modeling may be conducted and how the results may be used. One possible approach is shown in FIG. 3. In step 305, the PMP 105 gathers information and data, such as was described in conjunction with FIG. 2. In step 310, the data is subjected to a predictive modeling analysis. Any suitable means of predictive modeling may be used. In step 315, the PMP 105 uses the results of the predictive modeling analysis 310 to determine those beneficiaries 115 who have, or at risk of developing, various medical conditions. The results of the predictive modeling analysis 310 are also used to identify those beneficiaries 115 who need further attention to their healthcare needs, for example those beneficiaries 115 whose treatment could be improved.

Once these beneficiaries 115 are identified, various approaches are determined or implemented to reduce or eliminate the identified healthcare conditions or risks. These approaches are generally referred to as an “intervention plan” 320. By reducing or eliminating the healthcare conditions or risks in step 320, the healthcare costs associated with the beneficiaries' 115 healthcare needs may be reduced or eliminated. The PMP 105 or other healthcare entities implement the intervention plan in step 325.

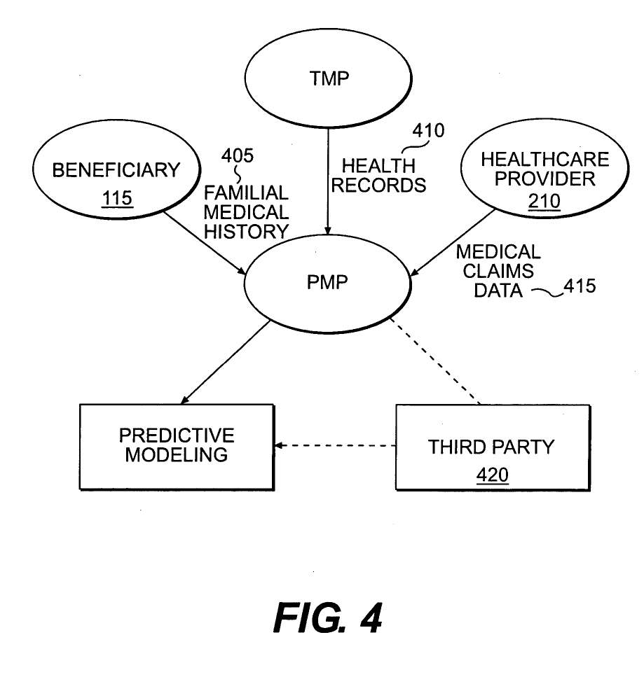

With reference to FIG. 4, different types of data may be utilized for predictive modeling, which may be carried out by the PMP 105 or at the PMP's 105 direction. In one embodiment, a beneficiary's 115 familial medical history 405 is utilized to determine the likelihood that a beneficiary 115 will incur a genetic disease. For instance, a male beneficiary 115 may have numerous male family members who have had a heart attack. The utilization of such information in predictive modeling may help determine the probability that the beneficiary 115 would also incur a heart attack. Early identification of this risk allows treatments to be implemented, potentially reducing the risk of a heart attack occurring, or reducing the severity of a heart attack.

Data from a beneficiary's 115 health records 410 are typically obtained from various healthcare entities, including a TPA 205, and used in predictive modeling. Health records 410 usually contain information such as a historical profile of the beneficiary's 115 medical conditions and treatments associated with such conditions. For example, a beneficiary 115 may have torn his or her anterior cruciate ligament on one knee and have undergone reconstructive surgery to repair the ligament. Such information is used to determine the likelihood that the beneficiary 115 will need another surgery on the knee in the future.

Health records 410 provide medical information regarding ongoing medical conditions, which is useful for various assessments. For example, a beneficiary 115 may have a current obesity problem. This information may be used to determine the likelihood that the beneficiary 115 will develop medical conditions in the future, such as adult-onset diabetes, as a result of the obesity. Identification of the potential future medical condition allows future healthcare costs to be estimated and preventative strategies to be put into place in order to reduce the healthcare costs.

In at least one embodiment, medical claims data 415 is obtained from healthcare entities, such as a medical service provider 210, and used in the predictive modeling analysis. The medical claims data 415 typically contains information pertaining to the healthcare services that a beneficiary 115 has utilized, which can be used to assess or estimate future healthcare needs. For example, the claims may include charges showing that the beneficiary 115 has undergone physical therapy for lower back pain as a result of a car accident. Such information can be used to assess the likelihood that the beneficiary 115 will need to undergo similar treatment for the same medical condition in the future, or whether other related conditions are likely to develop.

The data for predictive modeling may be analyzed using a variety of methods. For example, the PMP 105 may perform the analysis using various predictive modeling technologies, such as the predictive modeling technology available from MEDai, Inc. of Orlando, Fla. The predictive modeling technology may encompass various statistical programs, algorithms, and other computer methodology.

In certain embodiments, the PMP 105 outsources the data to be analyzed to a third party 420. In further embodiments, the PMP 105 has one or more third parties 420 both collect and analyze the data. For example, the PMP 105 instructs an entity, such as the medical service provider 210, to directly send the medical data for a beneficiary 115 to the third party 420. The third party 420 then performs the predictive modeling analysis for the PMP 105.

In certain embodiments, once a present medical condition, or the risk of developing a medical condition in the future, is identified, the data is further analyzed to determine whether there are ways to eliminate or reduce either the current or potential future costs associated with the condition. For example, the data is analyzed to determine whether intervention strategies can be developed to reduce or eliminate the costs associated with the condition. As an example, once a determination is made that a beneficiary 115 is predisposed to develop heart disease, the beneficiary's 115 diet and lifestyle may be altered, such as by establishing meal plans and an exercise regimen. Such measures may prevent the heart disease from occurring in the beneficiary 115, or may reduce the severity of the heart disease, should it develop. Accordingly, the intervention may eliminate or reduce the need for medical treatment that may have otherwise been necessary; correspondingly reducing the associated medical costs.

Development and Implementation of Intervention Strategies

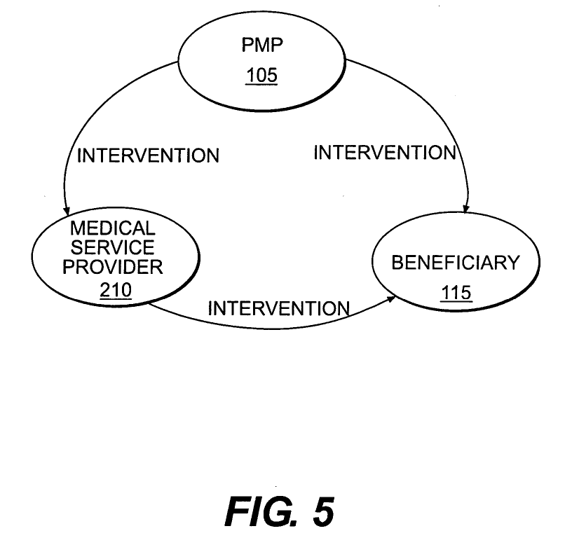

Once the predictive modeling analysis is performed, development and implementation of intervention strategies may be carried out in a variety of ways. In at least one embodiment, the PMP 105 develops and carries out the intervention strategy directly, such as is shown in FIG. 5.

The PMP 105 employs people, such as doctors, pharmacists or nurses, to review the predictive health data, identify potential healthcare issues, and develop intervention strategies. Intervention strategies often involve activities such as working with the beneficiary 115 directly such as to alter the beneficiary's 115 lifestyle. For example, the PMP 105 determines, through predictive modeling, that a beneficiary 115, who is obese, an avid smoker, and has a family history of heart problems, has a seventy percent chance of incurring a heart attack. If such a heart attack were to happen, the medical costs would be quite high due to various medical treatments would be necessary, such as an open-heart surgery, expensive medications, and hospitalization.

The PMP 105 then determines that, to lessen the possibility of a heart attack, the beneficiary 115 needs to lose weight and quit smoking. As a result, the PMP 105 develops a diet regimen, such as one consisting of low fat and low cholesterol meals, for the beneficiary 115 to follow. The PMP 105 develops an exercise routine to address the beneficiary's 115 weight, such as walking five times a week. In addition, the PMP 105 assists the beneficiary 115 in quitting smoking by providing support or aids, such as nicotine patches. All of these interventions may lessen the likelihood that the beneficiary 115 would incur a heart attack; thereby reducing the beneficiary's 115 potential health care costs.

The PMP 105 may also monitor the beneficiary 115 and his or her activities, so as to prevent any medical emergencies or accidents that would otherwise be costly. For example, a beneficiary 115 with epilepsy may have periodic seizures throughout the day. The PMP 105 monitors the beneficiary using a beeper, body monitor, or other means. If the beneficiary 115 were to have a seizure, he or she could push a button on the beeper to notify the PMP 105, or the body monitor sends signals to alert the PMP 105. Subsequently, the PMP 105 sends staff to treat the beneficiary 115 directly. Such a process may prevent other medical service providers 210, such as emergency medical technicians or other ambulatory care staff, from having to treat the beneficiary 115, which can be costly. As a result, having the PMP 105 directly monitor such a situation could be cost effective. Of course, the PMP 105 can contact emergency personnel, such as calling 911, to assist the beneficiary 115. In either case, the earlier the PMP 105 is alerted to the beneficiary's 105 condition, the more quickly the beneficiary 115 may be treated, possibly reducing any medical consequences and their attendant costs.

The PMP 105 may also directly treat the beneficiary 115 to carry out an intervention plan. In at least one embodiment, the PMP 105 has staff members, such as a nurse, that may provide a beneficiary 115 with diabetes his or her insulin shot at home. This service saves the beneficiary 115 a trip to the hospital; therefore, medical service provider 210 fees, such as would result from a hospital visit, can be avoided.

In further embodiments, the PMP 105 works with another healthcare entity, such as a medical service provider 210, to develop and implement appropriate intervention strategies for the beneficiary 115. For example, a medical service provider 210, such as a physician, may be treating a beneficiary 115 who has anemia. The PMP 105 and the medical service provider 210 develop a meal plan together for the beneficiary 115, such as meals that contain high iron levels. Furthermore, both the medical service provider 210 and PMP 105 can work together in monitoring the beneficiary 115, so that he or she follows the plan to prevent any need for a blood transfusion or expensive medications in the future.

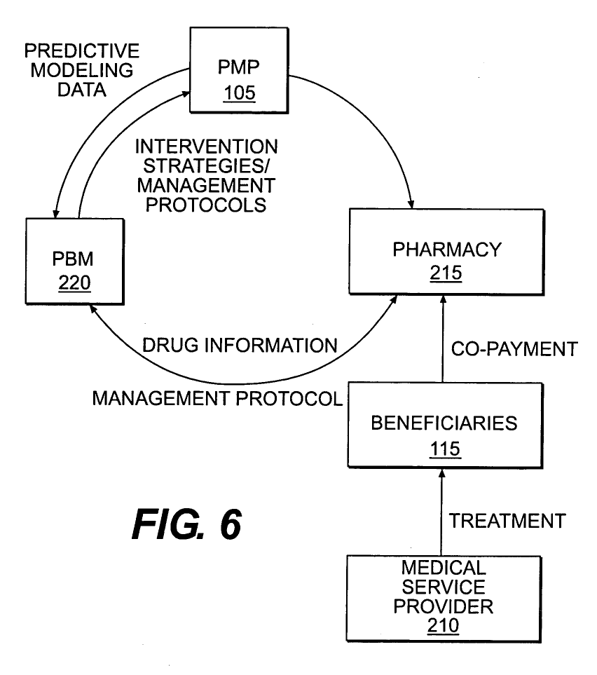

In further embodiments, the PMP 105 works with an outside entity to develop and carry out the intervention strategy. One possible set of relationships is shown in FIG. 6. As shown, the PMP 105 works with the PBM 220 to determine cost effective strategies for a client's 110 and a beneficiary's 115 drug expenses. The PMP 105 provides predictive healthcare data to the PBM 220 so that the PBM 220 can use such information to assess various treatments that would be more beneficial and cost effective for the beneficiary 115.

In one example, a medical service provider 210 advises a beneficiary 115 that he or she has high cholesterol and prescribe a cholesterol lowering prescription drug. The beneficiary 115 takes the prescription to the pharmacy 215 to receive the drug, at which point the PBM 220 advises the pharmacy 215 of a similar treatment, such as the generic version of the drug. The generic drug would have a similar effect but be less expensive than the original drug the medical service provider 210 had suggested.

In other embodiments, the PBM 220 develops a management protocol, such as by establishing and implementing co-payment options on new drugs, to minimize the client's 110 expenses. For example, a beneficiary 115 may have a dermatological condition, such as acne, and sees a medical service provider 210 to treat the condition. The medical service provider 210 decides to give the beneficiary 115 a prescription for a new type of acne drug. The PBM 220 is unable to substitute an alternative drug because the generic version is not yet available. Thus, the PBM 220 implements a higher co-payment on the prescribed drug to reduce the costs of the drug. Higher co-payments, or outright exclusions, may also be instituted on medications that are deemed elective, such as, in certain circumstances, birth control pills or tobacco dependence treatments.

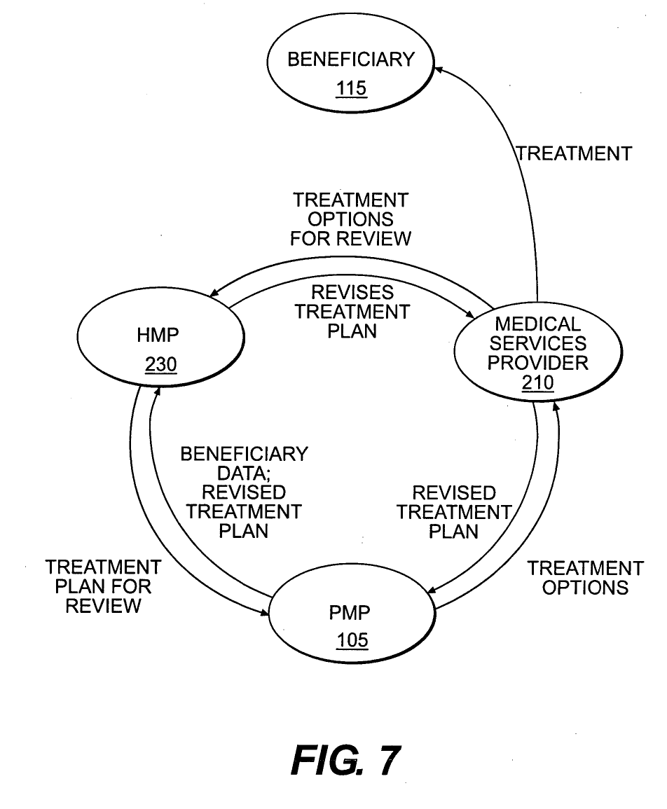

With reference now to FIG. 7, in certain embodiments, the intervention strategy is developed by one healthcare entity while another healthcare entity carries out the intervention strategy. For instance, a beneficiary 115 may see a medical service provider 210 for a given condition and the medical service provider 210 suggests various treatment options. These various treatment options are reviewed by an HMP 230. In reviewing the various treatment options, the HMP 230 also considers data about the beneficiary 115 the HMP received from the PMP 105.

The HMP 230 reviews the treatment options, beneficiary data, and determines the most appropriate and cost effective treatment plan for the beneficiary 115. The HMP 230 then informs the medical service provider 210 of the plan to be implemented. In further embodiments, the PMP 105 determines the most appropriate treatment option and informs the HMP 230 of the plan to be implemented. The HMP then relays this information to the medical service provider 210. On the other hand, the PMP 105 may directly inform the medical service provider 210 of the most appropriate treatment option to provide to the beneficiary 115.

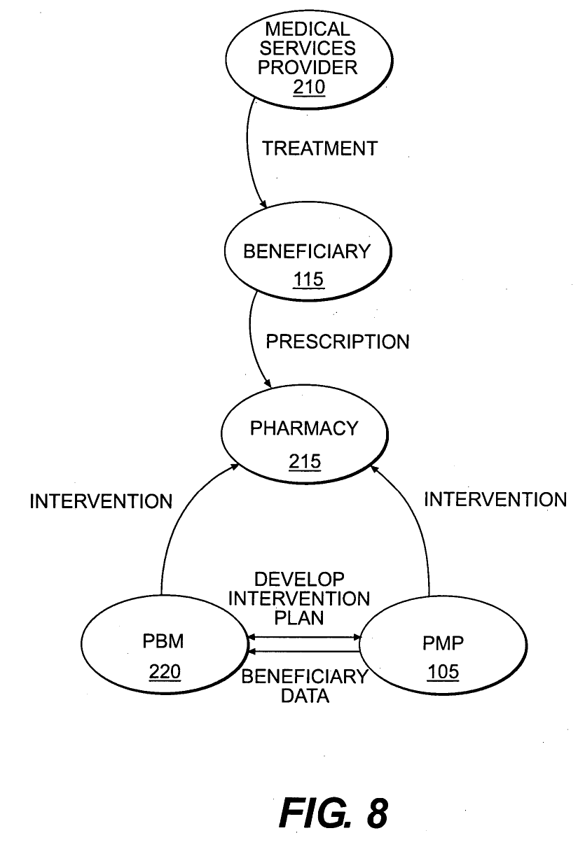

In another embodiment, shown in FIG. 8, the PMP 105 cooperates with another entity in developing and carrying out an intervention plan. For example, the beneficiary 115, who has been given a prescription by a medical service provider 210 submits the prescription to the pharmacy 215. The pharmacy 215 then gives information regarding the prescription to the PBM 220. The PBM 220 may also receive data about the beneficiary 115 from the PMP 105.

Once all the information is gathered by the PMP 105 and PBM 220, there are various approaches as to the development and implementation of an intervention plan. In one embodiment, the PMP 105 and PBM 220 develop and implement a strategy together. In another embodiment, the PMP 105 develops the strategy and the PBM 220 implements the strategy or the PBM 220 develops the strategy for the PMP 105 to implement. The PMP 105 may also work directly with a pharmacy 215. For example, the PMP 105 develops a strategy for, or with, the pharmacy 215. The pharmacy 215 then implements the strategy.

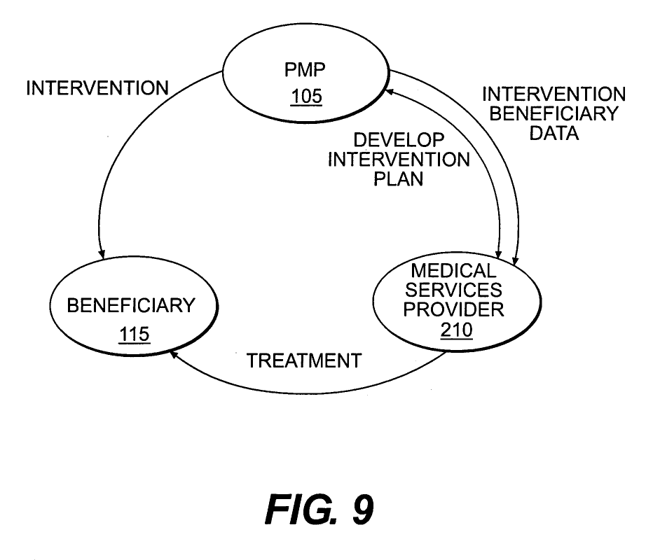

Turning now to the embodiment shown in FIG. 9, the intervention strategy is carried out in a cooperative manner by the PMP 105 and a medical service provider 210 to improve the quality of care given to the beneficiary 115. The PMP 105 uses predictive modeling to identify medical service providers 210, such as physicians, with high risk beneficiaries or beneficiaries 115 who are not following their treatment plans or whose treatment plans do not comply with established guidelines. The PMP 105 works with these medical service providers 210 one-on-one to deliver appropriate health care to the beneficiaries 115. The PMP 105 also develops standards or uniform screening methods for the medical service providers 210 to use in assessing and treating beneficiaries 115. For example, the PMP 105 may determine that all beneficiaries at risk of developing a particular disease should follow a particular treatment regime to reduce their risk. In another embodiment, the PMP 105 reviews the beneficiary's treatment to see that it complies with recommendations of established medical organizations such as the American Medical Association, the American Heart Association, and the American Diabetes Association.

Creation and Utilization of a Healthcare Database

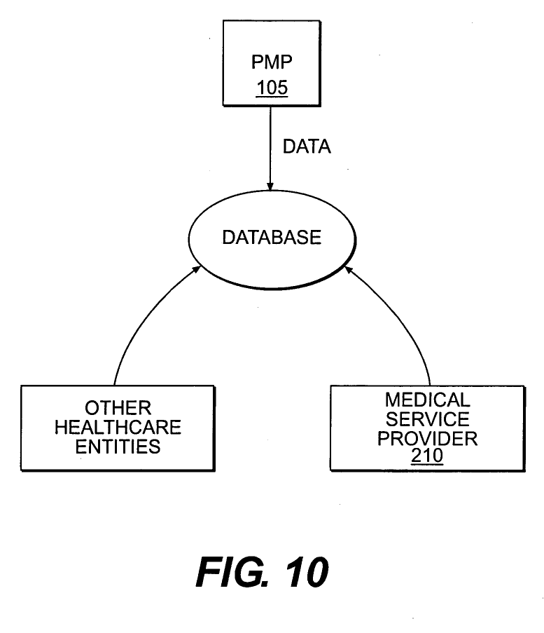

In the embodiment shown in FIG. 10, the PMP 105 maintains a database of medical and pharmaceutical claims that contains healthcare data related to the beneficiaries 115 services by the PMP 105. The healthcare data in the database includes predictive modeling data, data regarding current healthcare treatments, patient history, and family medical history. In at least certain embodiments, the database of medical and pharmaceutical claims is updated frequently, such as in real time, ensuring that those looking at the database have the most current and complete information available. In a further embodiment, the database contains various types of information regarding each beneficiary 115, including a beneficiary profile, a risk profile, and an impact profile.

The beneficiary 115 profile includes various information about the beneficiary 115, such as height, weight, age, risk factors, current health condition, current documentation regarding recent doctor visits, and physical evaluations. The beneficiary 115 risk profile consists of information regarding the beneficiary's 115 risk of developing various conditions, which may have been identified by analyzing risk factors, familial medical history, and the results of the predictive modeling analysis. The beneficiary 115 impact profile contains information regarding a beneficiary's 115 condition, such as whether a beneficiary 115 displays symptoms of a condition, whether the beneficiary 115 has had a physical effect as a result of a medical condition, current treatments which are being implemented for the beneficiary's 115 condition, and the results of such treatments.

In certain embodiments, the PMP 105 provides this database to various healthcare entities, such as medical service providers 210 including physicians, so that the healthcare entities can access a beneficiary's 115 data. The data contained in the database may enable the medical service providers 210 to give better care to the beneficiary 115. For example, a physician having access to a beneficiary's 115 medical history could find out if the beneficiary 115 is allergic to any drugs. This information enables the physician to find suitable drug treatments for the beneficiary while minimizing the potential of the beneficiary 115 developing side effects or any allergic reactions.

Such care may also be cost effective since such information would lead to more rapid or effective treatment. For example, a physician can more accurately diagnose the beneficiary 115 if the physician has access to the beneficiary's complete healthcare data. The accurate diagnosis may both prevent unnecessary treatments and provide the correct treatment as soon as possible, possibly increasing the effectiveness of the treatment. If the physician becomes aware of new treatments for a particular condition, the physician queries the database to find beneficiaries 115 who stand to benefit from the new treatment.

In addition, database access may used by various entities for data mining purposes. In one example, the database is used to refine the predictive modeling algorithms. In another example, the database is used to assess various medical conditions, such as comparing the health backgrounds of beneficiaries 115 to healthcare conditions experienced by the beneficiaries 115.

Business Methods Involving the PMP

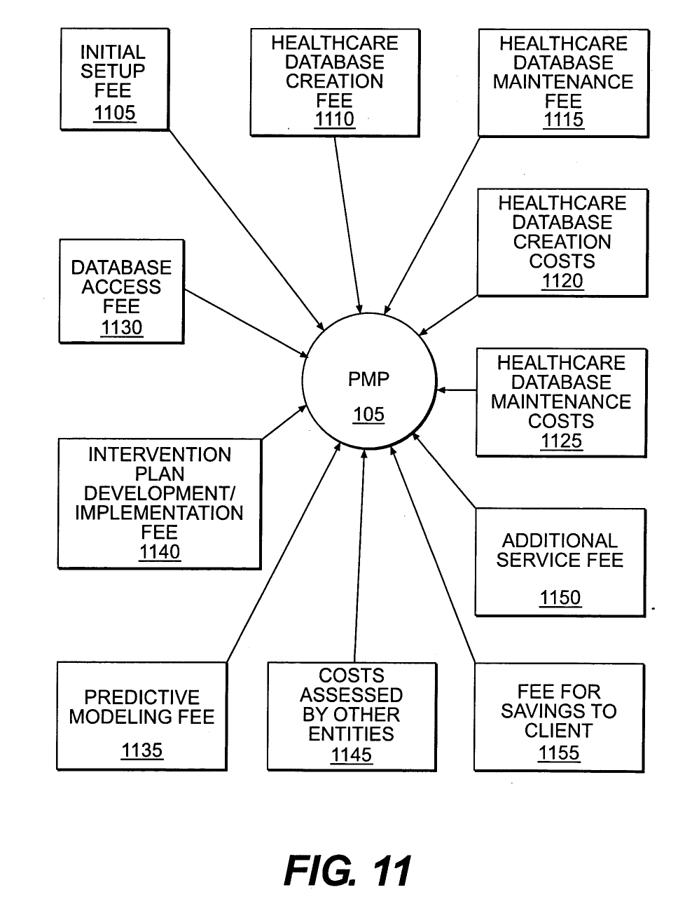

In certain embodiments, including the embodiment summarized in FIG. 11, the PMP 105 is run as a business and charge fees for providing various services to its clients 110. One such fee is an initial setup fee 1105, which consists of a fee for the initial execution of the services that the PMP 105 provides to its clients 110, for a given period. The setup fee may also include a fee for setting up the PMP's 105 system to interface with the client's 110 datastream. For example, the data from different client's 110 often come from different providers, in different formats, and contain different information. Accordingly, the PMP 105 may have to adjust its systems in order to use the client's 110 data.

Others fees chargeable by the PMP 105 include a healthcare database creation fee 1110 and a healthcare database maintenance fee 1115. Similarly, the PMP may charge a fee 1120 for the costs that the PMP 105 incurs in creating a healthcare database 1120 and a fee 1125 for the costs associated with maintaining the healthcare database. In at least one embodiment, the PMP 105 charges a database access fee 1130 for providing database access to various entities.

In further embodiments, the PMP 105 charges a predictive health fee 1135 for performing a predictive health analysis. The PMP also charges an intervention fee 1140 for the services that it performs with the predictive health analysis results, such as developing and implementing intervention strategies.

The various fees, including the predictive health analysis fee 1135 and the intervention strategy fee 1140 may be charged in a number of ways. In at least one embodiment, the PMP 105 charges a certain amount for each beneficiary 115 that the PMP 105 performs a predictive healthcare analysis on. Similarly, in a further embodiment, the PMP 105 charges a certain fee for each beneficiary 115 that it develops and implements an intervention strategy for. In yet further embodiments, the fees are based on the number of beneficiaries 115 the PMP 105 must oversee. Each of these fees may be one-time fees or periodic recurring fees. In one example, the PMP 105 charges the client 110 a monthly fee based on the number of beneficiaries 115 the PMP 105 oversees.

In embodiments of the invention the PMP 105 bills to the client 110 one or more charges 1145 that result from fees charged to the PMP 105 by other entities. For example, the TPA 205, PBM 220, or medical service provider 210 charge the PMP 105 for the information and data that the PMP 105 obtains from them. In a further example, these charges are for costs incurred by other entities for formatting the information and data in a manner acceptable to the PMP 105 or for the cost of materials, postage, and the like. Furthermore, additional service fees 1150 are charged by the PMP 105 for any additional services provided to its clients 110.

In certain embodiments, the PMP 105 is provided with incentives to reduce healthcare costs. In one example, the PMP 105 charges as a fee 1155 a percentage of the discount and savings that result from its efforts. Therefore, the more savings the PMP 105 delivers to the client 110, the more money the PMP 105 will receive. In another example, the PMP 105 is motivated to save the client 110 money since, unlike an insurance company, the client 110 is paying the PMP 105 specifically for potentially cost saving services. In contrast, an insurance company often simply passes on higher costs to the client 110.

Improved health of the beneficiaries 115 may have a number of other benefits. The employer benefits from reduced absenteeism and productivity due to employee illness. The PMP's 105 motivation to save money benefits the beneficiaries 115 because the PMP 105 is motivated to make sure the beneficiaries 115 are receiving the best possible healthcare. If the client 110 spends less on healthcare costs, the client may be able to provide greater raises or other benefits to employee beneficiaries 115. The better the quality of healthcare, and other benefits such as higher salary, the employer 110 can provide, the greater incentive the employees have to keep working for the employer 110.

Healthcare Management by an Integrated Benefits Management Organization

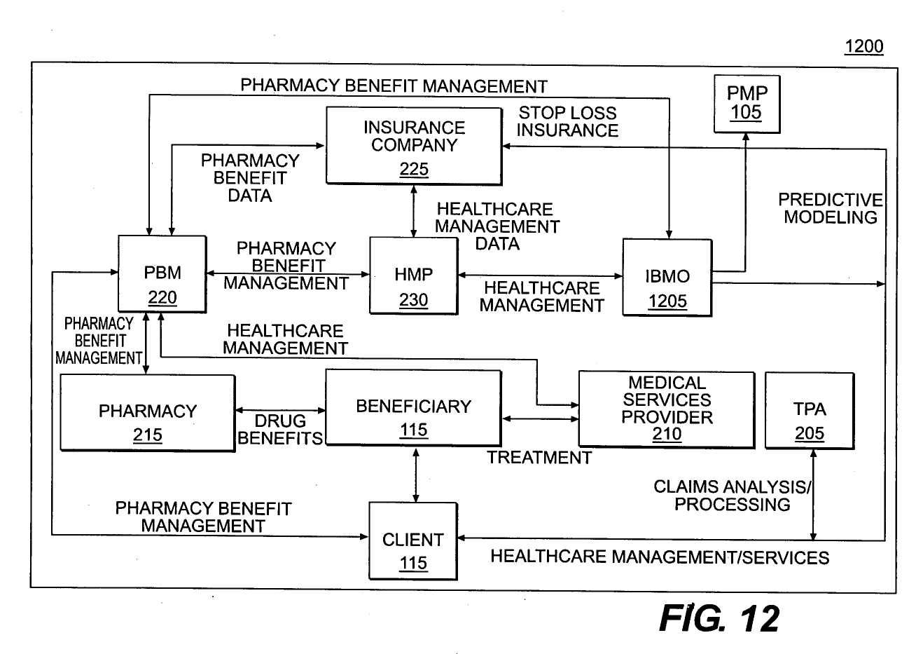

FIG. 12 shows a set of relationships by which an Integrated Benefits Management Organization (IBMO) 1205, or another entity hired by the IBMO 1205 (collectively referred to herein as an “IBMO”) manage, or assist in managing, the healthcare services of a client 110. In at least certain embodiments, the client 110 is at least partially self-insured. Because the client 110 is at least partially self-insured, the client may not otherwise have assistance in managing its healthcare program, functions that might normally be carried out or coordinated by an insurance provider. The IBMO 1205 is hired by the client 110 to fill any such gaps in healthcare management.

Managing the healthcare program often includes having the IBMO 1205 integrate or establish relationship between one or more entities. Entities with which the IBMO works include one or more beneficiaries 115, pharmacies 215, PBMs 220, HMP 230s, medical service providers 210, TPAs 205, and insurance companies 225 (i.e., a stop-loss insurance carrier).

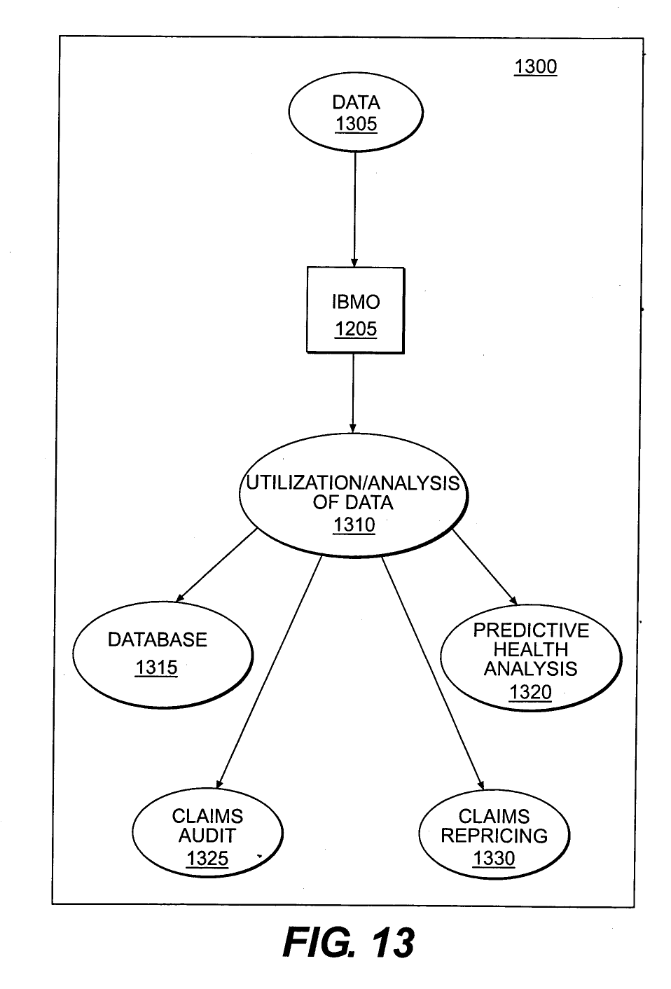

In managing the healthcare services, the IBMO 1205 provides one or more services to a client 110 or another entity (such as an insurance company 225), such in the embodiment illustrated in FIG. 13.

In step 1305, the IBMO 1205 collects data from the various healthcare entities that it has established relationships with. In step 1310, the IBMO 1205 utilizes the data for various purposes, including various analyses. For example, in step 1315, the IBMO 1205 uses the data to populate a database which is used for various purposes by the IBMO 1205 or other entities. In step 1320, the IBMO 1205 provides predictive health care services, essentially acting as a PMP 105 as discussed above.

The IBMO 1205 may perform other services for one or more clients 110. For example, in step 1325, the IBMO 1205 performs a claims audit on claims for one or more beneficiaries 115. The IBMO 1205 reprices claims, determining the proper amount of the claim and seeking to obtain claim discounts, in step 1330. The claim audit process 1325 and claim repricing process 1330 are described further below.

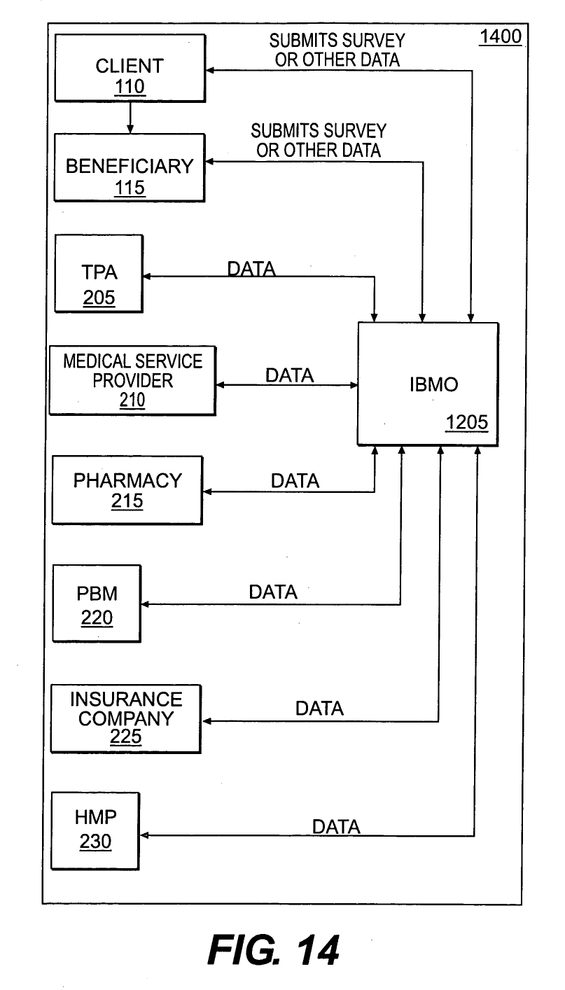

As shown in FIG. 14, the IBMO 1205 collects a variety of data from a variety of entities. The data collection is similar to the collection of data by a PMP 105, as discussed above. In one example, the IBMO 1205 distributes a questionnaire or survey to beneficiaries 115 regarding their health or healthcare expenses. Similarly, the IBMO distributes a survey to the client 110 regarding the clients' 110 healthcare expenses. The IBMO 1205 collects data regarding the health and healthcare claims of the beneficiaries 115 from one or more entities, including a TPA 205, a medical service provider 210, a pharmacy 215, a PBM 220, an insurance company 225, or HMP 230. Data may be obtained in tangible or electronic form.

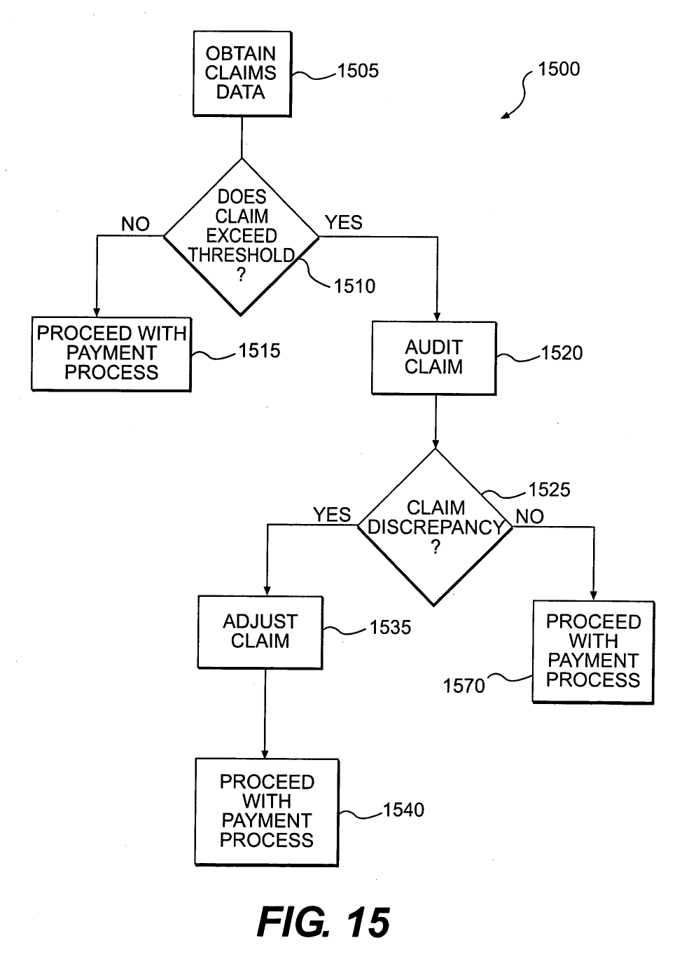

As shown in the flowchart depicted in FIG. 15, in at least one embodiment, an IBMO 1205 performs an audit 1500 on the claims data. The IBMO 1205 performs the audit 1500 on the claims to determine whether the charges were based on unnecessary claims, fraudulent claims, services that were not actually performed, or were of higher than average costs. Unnecessary claims may include claims that charge for redundant services. For example, a client 110 may be charged twice for a beneficiary's 115 procedure or service. Unnecessary claims may include claims for services that were not medically necessary. For instance, the IBMO may identify a test that was performed by a medical service provider 210 that was not warranted given the beneficiary's condition. The IBMO 1205 corrects the claims, deducting any inappropriate charges, and notifies the TPA 205 accordingly.

Fraudulent claims include claims that include charges based on false or incorrect claims. For instance, a beneficiary 115 may have produced false documents, such as bills, for a certain medical procedure, and then submitted such false claims to the client 110. The IBMO 1205 then verifies such claims to see if they are accurate. Similarly, a medical service provider may try and submit claims for services that were not performed or were not warranted. If the IBMO determined the claims are fraudulent, the IBMO takes steps to notify TPA 205 and ensure that the client 110 is not charged for the fraudulent claims and other appropriate action.

The IBMO 1205 also seeks to identify claims based on services not performed. For example, a beneficiary 115 may receive medical attention for a toe fracture, including an order by a medical service provider 210 for an x-ray to determine the severity of the fracture. The client 110 was charged for an x-ray and was erroneously charged with a magnetic resonance imaging (MRI) test. The IBMO 1205 identifies and instructs TPA 205 to deduct the erroneous MRI charge, since the beneficiary 115 never received such a service.

Claims based on higher than average costs include charges for services that are relatively higher than the going rate for such services in a particular geographic area. As an example, a client 110 was charged a very high amount for the beneficiary's 115 use of a bed during an inpatient hospital stay. The IBMO 1205 examines the going rates for the use of hospital beds in the area and determines that the charge is unacceptable. The IBMO 1205 works with the medical service provider 210 to adjust the amount of the claim to a reasonable charge.

In certain embodiments, the audit process 1500 is performed manually. In further embodiments, the audit process 1500 is automated, such as using computers to analyze claim data. In yet further embodiments, the computers use a heuristic approach to analyze the claims data and identify provider patterns for fraud, abuse, or incorrect charges.

With continued reference to FIG. 15, at step 1505 of the claims audit process 1500, the IBMO 1205 collects claims data from various entities by the method described above, such as was described in conjunction with FIG. 14. At decision 1510, the IBMO 1205 ascertains whether the charges in the claims data exceed a given threshold for analysis and potential recovery. If the claims data does not exceed the threshold, then no audit is performed and the claim proceeds for payment in step 1515. If it is determined in decision 1510 that the claims data exceeds the threshold, then an audit is performed in step 1520. In at least certain embodiment, this audit 1520 involves a detailed line-by-line analysis of the claims. In further embodiments, no threshold claim value is used and all claims are subjected to the audit of step 1520.

In decision 1525, if no claim discrepancy is found between the billed charge and the correct charge, the claim proceeds with the payment process in step 1530. If a claim discrepancy is found at decision 1525, the claim is appropriately adjusted in step 1535. The claim then proceeds with the payment process in step 1540.

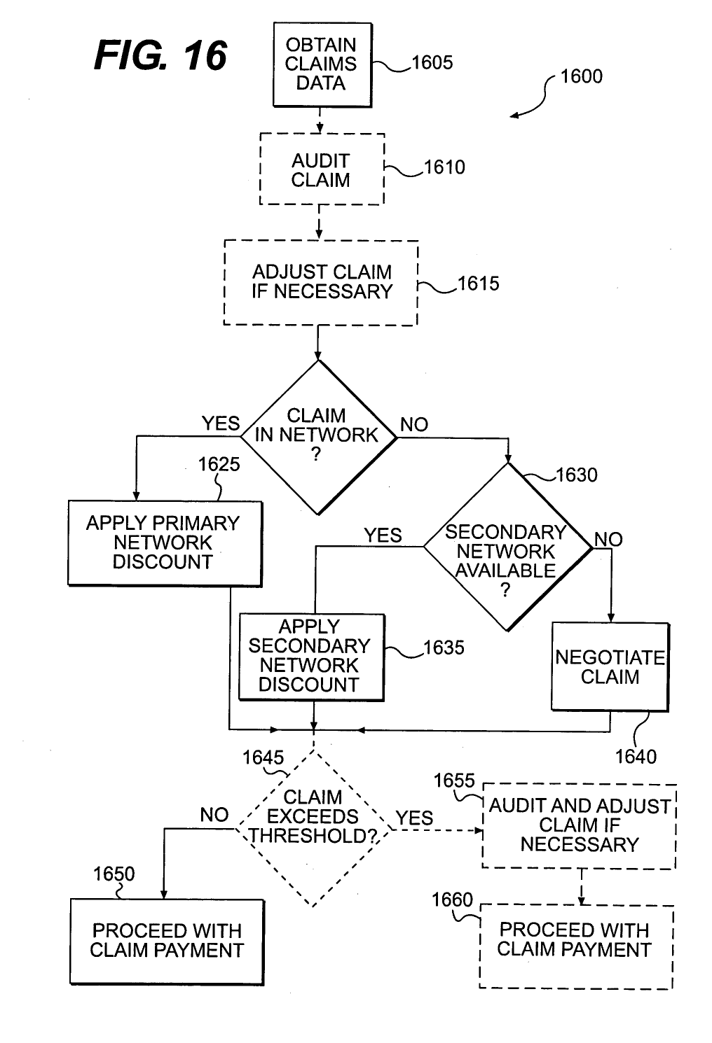

As shown in FIG. 16, an IBMO 1205 may also perform a claim repricing process 1600 on claims data. The claim repricing process may be a separate process or may occur during the claim audit process 1500. The claim repricing process seeks to reduce the amount of claims by applying appropriate discounts, seeking alternative discounts, or negotiating to obtain lower rates.

In step 1605, the IBMO 1205 obtains claims data from various entities, such as a TPA 205, such as was discussed in conjunction with FIG. 14. Optionally, the IBMO 1205 then performs the claim audit process 1500 (FIG. 15) in step 1610. In optional step 1615, adjustments are made to the claims, if necessary, in light of the results of the claim audit process 1500.

At decision 1620 the claims data are separated according to whether the claims originate from medical service providers who are in the beneficiary's primary care network claims or whether the claims originate from medical service providers 210 who are out of the beneficiary's 115 primary care network. The IBMO 1205 may have previously worked with the client 110 to subscribe to a primary care provider network. Primary care provider networks are associations of medical providers 210 who have agreed to provide discounted rates in return for the client's 110 beneficiaries 115 being required to normally utilize their services. If the claim is deemed to be a primary network claim, the claim is reviewed to ensure that the claim was given the appropriate primary network discount in step 1625.

On the other hand, if a claim is deemed in decision 1620 to be an out-of-network claim, the IBMO 1205 checks to see if a secondary network is available in step 1630. An example of a secondary network is a network of which the medical service provider 210 is a member of, but of which the beneficiary 115 is not a member. The medical service provider 210 may accept the network rate even though the beneficiary 115 is not a member in order to obtain faster payment or because of an agreement with the IBMO 1205 or the client 110. If a secondary network is applicable, then the claim is given the secondary network discount in step 1635. If no secondary network discount is available, the method 1600 proceeds to step 1640.

At step 1640, the IBMO 1205 tries to negotiate a lower claim. In at least one embodiment, the IBMO 1205 tries to take advantage of the fact that claims often take a significant amount of time to process. In at least one embodiment, the IBMO 1205 offers to expedite payment of a medical service provider's 210 claim in return for the medical service provider 210 accepting a lower amount to satisfy a claim. The method 1600 then proceeds to decision 1645.

Optionally, at decision 1645, once any appropriate discounts are applied to the claims, in steps 1625, 1635, or 1640, the IBMO 1205 determines whether the claims exceed a certain threshold. If the claim does not exceed the threshold, method 1600 proceeds to step 1650 where the claim is indicated as payable. If the claim exceeds the threshold, then the method 1600 optionally proceeds to step 1655 where an audit, such as audit process 1500, is performed. The audit may be a standard audit or may be a more detailed line-by-line audit. Any adjustments identified by the audit are made and then the method 1600 proceeds to step 1660 where the claim is indicated as payable.

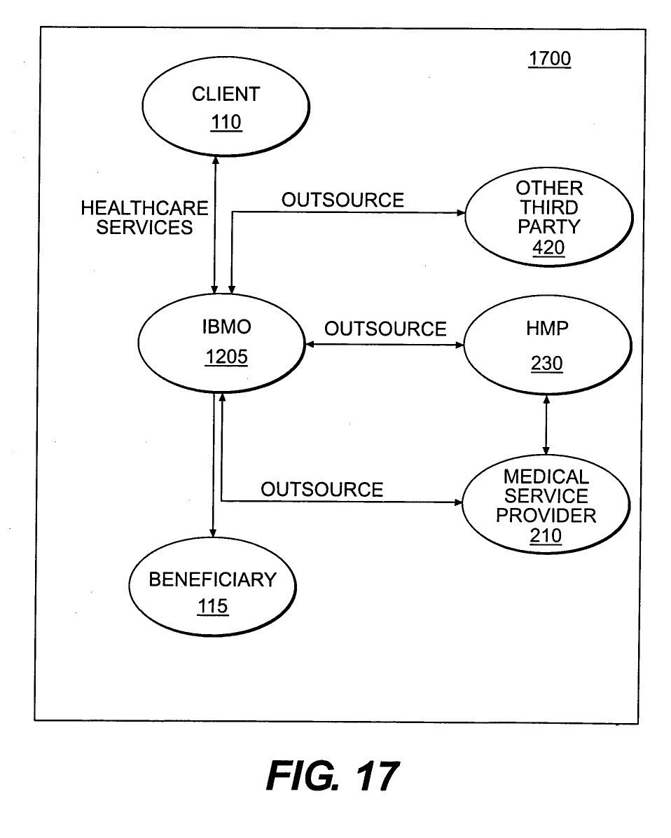

There are various ways in which the IBMO 1205 provides services to the client 110, some of which are illustrated in FIG. 17. In certain embodiments the IBMO 1205 provides the services directly to the client 110. For example, the IBMO 1205 collects the claims and perform the claim repricing method 1600. In other embodiments, the IBMO 1205 uses one or more third parties 1705 to carry out the IBMO's 1205 tasks. For example, the IBMO 1205 collects the claims data from various entities and transmit the claims data to a third party 1705, such as a TPA 205, who then performs the claim repricing process 1600. In another embodiment, the IBMO 1205 outsources certain healthcare services to a HMP 230, who then works with medical providers 210, such as in carrying out intervention plans. The interaction between the healthcare entities may be personal or automated, such as by electronic means.

Reporting

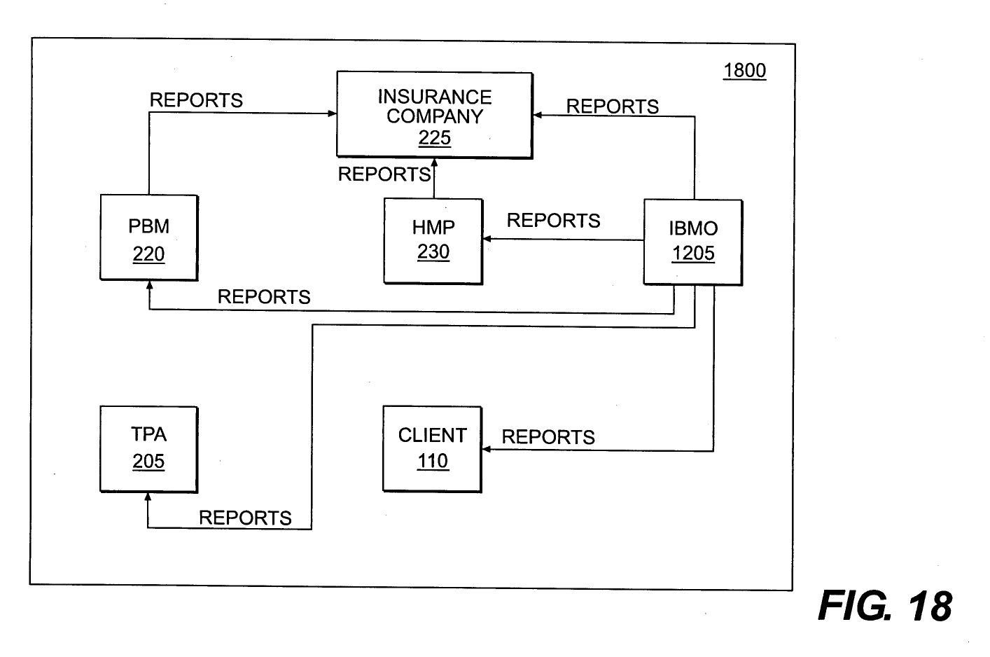

In certain embodiments, raw data, results of data analyses, or other reports are generate by, and submitted to various healthcare entities, including a client 110. In the embodiment of FIG. 18, the PBM 220 generates a report for submission to other healthcare entities, such as an insurance company 225 or TPA 205. The report contains information regarding a beneficiary's 115 drug treatments, their costs, and savings that have or may be realized using an intervention plan. The insurance company uses this information for one or more purposes, such as to adjust premiums charged to a client 110. The report is also provided to the client 110, who use the report for various purposes, including helping determine the appropriate level of funding or insurance coverage.

Similarly, the HMP 230 develops one or more reports, such as a report about a beneficiary's 115 medical care management, for submission to the insurance company 225. The HMP's 230 report contains information regarding a beneficiary's current treatments, their costs, alternative treatments and their costs, and savings that have been or may be realized using an intervention plan. The insurance company 225 may use this information to adjust premiums charged to a client 110. The report is also provided to the client 110, who may use the report to help determine the appropriate level of funding or insurance coverage.

In further embodiments, the IBMO 1205 creates one or more reports, such as a report regarding intervention strategies. The reports regarding intervention strategies include information such as a beneficiary's 115's current medical conditions, current treatment plans, the proposed intervention strategies, or information regarding potential health benefits or costs savings that may be realized by implementing the intervention plan. In yet further embodiments, the intervention strategy report is provided to other healthcare entities, such as an HMP 230, a PBM 220, a client 115, or insurance company 225. The healthcare entities use this data to evaluate or implement the intervention strategies, as well as to better plan for future medical expenses, such as maintaining an appropriate level of funding or insurance coverage.

In certain embodiments, the IBMO 1205 generates reports of claim audits 1500 and claim repricing 1600 results and transmits them to one or more entities, such as a TPA 205. The TPA 205 uses this information to pay the appropriate amount to medical providers 210 who submitted claims for beneficiaries 115 receiving healthcare coverage from a client 110. In a further embodiment, the IBMO 1205 submits the report to an insurance company 225 who uses the information to identify medical service providers who routinely submit unnecessary, fraudulent, or higher than average claims. In a yet further embodiment, the IBMO 1205 uses this data to refine the claim audit process 1500 or the claim repricing process 1600. In certain embodiments, the IBMO 1205 more carefully scrutinizes claims from medical service providers 210 who are identified as routinely submitting unnecessary, fraudulent, or above average claims.

In at least one embodiment the IBMO 1205 generates various reports for one or more clients 110. In one example, the IBMO 1205 generates a report summarizing claims made by each beneficiary during a particular time period. For each beneficiary 115, the report various information such as the beneficiary's 115 identity, the healthcare entity providing the healthcare service, the original amount of the claim, the adjusted claim (if any), and the allocation of responsibility for paying the adjusted claim (such as between the client 110, the beneficiary 115, and an insurance company 225, if any). The reason for any discrepancy between the charges billed by the provider and the adjusted claim is noted. In a further embodiment the client 110 is provided with a summary of savings realized by using the IBMO's 1205 services. The savings results from factors such as predictive healthcare modeling/intervention, the claim audit process 1500, or the claim repricing process 1600.

Business Methods Involving an Integrated Benefit Management Organization

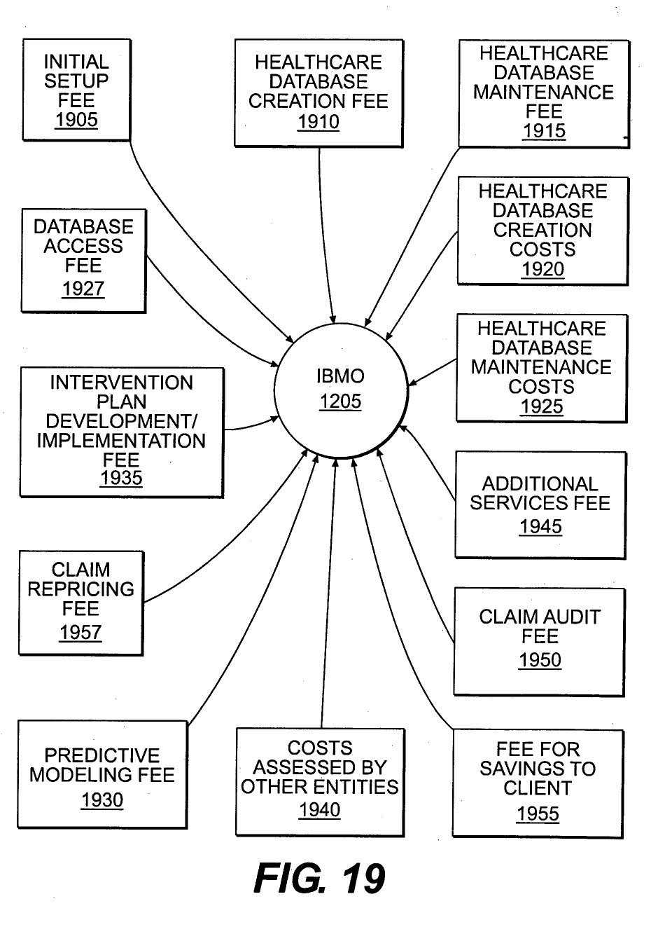

In certain embodiments, the IBMO 1205 is run as a business and charges one or more fees for providing various services to its clients 110, such as shown in the embodiment depicted in FIG. 19. One such fee is an initial setup fee 1905, which consists of a fee for the initial period of services that the IBMO 1205 provides to the clients 110. In a further embodiment, the setup fee 1905 also includes a fee for setting up the IBMO's 1205 system to interface with the client's 110 datastream. For example, the data from different client's 110 often comes from different providers, in different formats, and contains different information. Accordingly, the IBMO 1205 may have to adjust its systems in order to use the client's 110 data.

In certain embodiments the IBMO 1205 charges a healthcare database creation fee 1910 or a database maintenance fee 1915. Similarly, in further embodiments the IBMO 1205 charges a fee 1920 for the costs that the IBMO 1205 incurs in creating the healthcare database and a fee 1925 for the costs associated with maintaining the healthcare database. The healthcare database typically contains information such as a beneficiary's 115 medical data, medical history, case management information, and medical claims. In at least one embodiment, clients 110 and other entities are be able to access such a database for free, for a charge 1927, or as part of IBMO's 1205 services.

In certain embodiments the IBMO 1205 charges a fee 1930 for performing the predictive health analysis and charges a fee 1935 for the services that it performs with the predictive health analysis results, such as developing or implementing intervention strategies. In one example, the IBMO 1205 charges a certain amount for each beneficiary 115 that the IBMO 1205 performs a predictive health analysis on. In another example, the IBMO 1205 charges a certain fee for each beneficiary 115 for which the IBMO 1205 develops and implements an intervention strategy. In a further embodiment, the IBMO 1205 charges a fee 1955 for any savings realized by using intervention plans.

Certain charges the IBMO 1205 bills to the client 110 result from fees 1940 charged by other entities. For example, the TPA 205, PBM 220, laboratory vendor, or claims processor charge the IBMO 1205 a third party fee 1940 for the information and data that the IBMO 1205 obtains from them. In at least one embodiment, these third party fees 1940 result from the costs incurred by other entities for formatting the information and data in a manner acceptable to the IBMO 1205. Furthermore, additional service fees 1245 are charged by the IBMO 1205 for any additional services provided to its clients 110.

In at least one embodiment, the IBMO 1205 charges one or more fees 1950 for the claims audit process 1500 and one or more fees 1957 for the claims repricing process 1600. In at least one embodiment, the fees 1950, 1957 are periodic fees. In a further embodiment, the periodic fees 1950, 1957 are related to the number of beneficiaries 115 the IBMO 1205 is managing, such as charging a fee per beneficiary 115 per month. In another embodiment, the fee 1950 is a portion of any savings resulting from billing errors that are revealed in the claim audit process 1500. Similarly, in certain embodiments the IBMO 1205 retains as a fee 1957 a portion of any discounts or recovered costs savings that result from the claim repricing process 1600.

Embodiments of the present invention provide a fee structure that provides the IBMO 1205 with incentives to find healthcare savings for its clients 110. For example, in embodiments in which the IBMO 1205 receives a portion 1955 of the savings that result from billing errors that are identified in the claims audit process 1500, the more money the IBMO 1205 saves the clients, the larger the IBMO's 1205 fee 1955. Similarly, in the claims repricing process 1600, the more the IBMO 1205 can discount a beneficiary's 115 claims, the greater the IBMO's 1205 fee 1957. However, even when the IBMO's 1205 are not based on a percentage of client savings, the pay-for-service nature of the IBMO's 1205 business gives the IBMO 1205 a motivation to provide clients 110 with the best service possible.

The IBMO 1205 is likely to be more aligned with its clients' 110 interests than other healthcare entities, such as if the clients 110 had merely employed an insurance company 225 to manage the clients' 110 healthcare program. The insurance company 225 often simply passes along costs to the clients 110. For example, insurance companies 225 typically do not negotiate for lower prices when a claim is not in the beneficiary's 115 primary network. The insurance company 225 may not have an incentive to utilize secondary networks or negotiate lower claims. Furthermore, the insurance company 225 may not have the resources or personal to carry out the negotiations.

It can thus be seen that at least certain embodiments of the present invention may provide more affordable and better quality healthcare. In certain embodiments, a PMP 105 may determine ways to reduce healthcare costs, such as through performing a predictive healthcare analysis, developing intervention strategies, and implanting the intervention strategies. In further embodiments, an IBMO 1205 may reduce its clients' 110 healthcare costs by providing services such as a claims audit service 1500 or a claims repricing service 1600. The reduced healthcare costs may allow the clients 110 to provide more affordable and better healthcare services to their beneficiaries 115. The establishment of various relationships, such as the manner in which a PMP 105 works one-on-one with medical service providers 210, may improve the quality of care that can be provided to the beneficiaries 115. The quality of healthcare service may also be improved by the medical service providers 210 having faster and more complete access to information about the beneficiaries 115.

Although the methods and system of the present invention have been discussed in relation to healthcare claims, at least certain embodiments may find use in other areas. For example, predictive modeling data may be used in managing workman's compensation programs or in managing nursing home care. Intervention plans may be developed to reduce expenses associated with workman's compensation or nursing home programs. As with healthcare claims, workman's compensation claims may be audited and repriced. Furthermore, the predictive modeling and healthcare management methods and systems of embodiments of the present invention may be applied to animal health. For example, methods and systems according to the present invention may be used in managing and reducing veterinary claims.

What is claimed is:

1. A method of providing healthcare management services of the type useable to reduce healthcare costs associated with providing healthcare services to healthcare beneficiaries, the method of providing healthcare services comprising charging a fee for providing the following service to a customer:
obtaining disparate healthcare data from disparate healthcare entities;
performing a predictive modeling analysis on the disparate healthcare data;
identifying at least one healthcare condition to which a beneficiary may be susceptible; and
communicating the identified at least one healthcare condition to the customer.

2. The method of providing healthcare management services of claim 1, further comprising:
developing a treatment plan to at least reduce the severity of the identified at least one healthcare condition; and
implementing the treatment plan.

3. The method of providing healthcare management services of claim 2 wherein the step of implementing the treatment plan results in reduced healthcare costs.

4. The method of providing healthcare management services of claim 3, wherein the fee is related to the reduction in healthcare costs.

5. The method of providing healthcare management services of claim 1 wherein the customer is at least partially self-insured.

6. The method of providing healthcare management services of claim 1 wherein the customer is not in the business of providing healthcare insurance.

7. The method of providing healthcare management services of claim 1 further comprising, concurrently with performing the predictive modeling analysis, performing a treatment review of the disparate healthcare data.

8. The method of providing healthcare management services of claim 1 wherein the step of obtaining disparate healthcare data continues concurrently with the step of performing a predictive modeling analysis on the disparate healthcare data.

9. The method of providing healthcare management services of claim 1 further comprising concurrently with identifying at least one healthcare condition to which a beneficiary may be susceptible, performing a treatment review of the disparate healthcare data.

10. The method of providing healthcare management services of claim 1 wherein the service is provided to the customer on an ongoing basis.

11. The method of providing healthcare management services of claim 1 wherein the service is provided to a plurality of customers.

12. The method of providing healthcare management services of claim 11 wherein the customers are disparate.

13. A method of operating a healthcare management service of the type useable to reduce healthcare costs associated with providing healthcare services to healthcare beneficiaries, the method of operating a healthcare management service comprising, on an on-going basis, managing a healthcare service to reduce a customer's healthcare costs, interfacing with a plurality of healthcare entities, receiving healthcare data from each of the plurality of healthcare entities, analyzing the healthcare data, reducing the customer's healthcare costs, and charging a fee for managing the healthcare service.

14. The method of operating a healthcare management service of claim 13 wherein the healthcare management service is not in the business of providing healthcare insurance.

15. The method of operating a healthcare management service of claim 13, the step of reducing a customer's healthcare costs comprising performing a claim audit service.

16. The method of operating a healthcare management service of claim 13, the step of reducing a customer's healthcare costs comprising performing a claim repricing process.

17. The method of operating a healthcare management service of claim 13, the step of reducing a customer's healthcare costs comprising performing a predictive health analysis.

18. The method of operating a healthcare management service of claim 13, wherein the fee is a percentage of an amount by which the customer's healthcare costs are reduced.

19. The method of operating a healthcare management service of claim 13, the step of reducing a customer's healthcare costs comprising managing healthcare of a plurality of beneficiaries, the fee being related to the number of beneficiaries.

20. The method of operating a healthcare management service of claim 19, wherein the fee is charged periodically.

21. A method of providing healthcare management services of the type useable to reduce healthcare costs associated with providing healthcare services to healthcare beneficiaries, the method of providing healthcare services comprising charging a fee for providing the following service on an on-going basis to an at least partially self-insured employer providing a healthcare plan for a plurality of beneficiaries:
obtaining healthcare data from a plurality of healthcare entities, the healthcare data comprising healthcare claims having a value;
performing a claim adjustment process comprising reducing the value of the healthcare claims.

22. The method of providing healthcare management services of claim 21, wherein the fee is proportional to the reduction in value of the healthcare claims.

23. The method of providing healthcare management services of claim 21, wherein the claim adjustment process comprises, for each claim:
determining if the claim is a primary network claim;
if the claim is not a primary network claim, determining if a secondary network is available;
if a secondary network is available, reducing the value of the healthcare claim to a lower value; and
if a secondary network is not available, negotiating the value of the healthcare claim with the appropriate healthcare entity of the plurality of healthcare entities to a lower value.

24. The method of providing healthcare management services of claim 23, wherein the fee is a percentage of the difference between the value of the healthcare claim and the lower value.

25. A method of managing a healthcare service comprising charging a fee for, on an on-going basis, obtaining healthcare data, performing predictive modeling on the healthcare data to give predictive health data, and concurrently analyzing the predictive health data and the healthcare data.

26. The method of claim 25 wherein the healthcare data comprises current and historical healthcare data.

27. A method of providing healthcare management services of the type useable to reduce healthcare costs associated with providing healthcare services to healthcare beneficiaries, the method of providing healthcare management services comprising an integrated benefits management organization at least overseeing an on-going process of:
obtaining healthcare data from a plurality of healthcare entities;
analyzing the healthcare data;
identifying a plurality of healthcare issues indicated by the healthcare data;
developing strategies to address the healthcare issues;
implementing the strategies.

28. The method of claim 27, the step of obtaining healthcare data from a plurality of healthcare entities comprising a healthcare beneficiary filling out a health questionnaire.

29. The method of claim 27, the step of obtaining healthcare data from a plurality of healthcare entities comprising obtaining healthcare data from a medical provider.

30. The method of claim 27, the step of obtaining healthcare data from a plurality of healthcare entities comprises obtaining healthcare data from a pharmaceutical benefits manager.

31. The method of claim 27, the step of obtaining healthcare data from a plurality of healthcare entities comprises obtaining healthcare data from a third party administrator.

32. The method of claim 27, wherein the integrated benefits management organization analyzes the healthcare data.

33. The method of claim 27, wherein the integrated benefits management organization has an outside source analyze the healthcare data.

34. The method of claim 27, wherein the healthcare data comprises claims data for a plurality of healthcare claims associated with a plurality of healthcare beneficiaries and the step of analyzing the healthcare data comprises auditing at least a portion of the plurality of healthcare claims.

35. The method of claim 34, wherein the step of auditing the plurality of healthcare claims is performed for each healthcare claim of the plurality of healthcare claims that exceeds a threshold.

36. The method of claim 35 wherein the audit is a line-by-line audit.

37. The method of claim 34, further comprising the integrated benefits management organization charging a fee for the audit.

38. The method of claim 37, wherein the fee comprises a percentage of an amount recovered by performing the audit.

39. The method of claim 27, wherein the healthcare data comprises claims data for a plurality of healthcare claims associated with a plurality of healthcare beneficiaries and the step of analyzing the healthcare data comprises performing a claim repricing process comprising, for each healthcare claim of the plurality of healthcare claims:
determining if the healthcare claim is a primary network claim;
if the healthcare claim is not a primary network claim, determining if a secondary network is available;
if a secondary network is available, reducing the amount of the healthcare claim to a secondary network rate; and
if a secondary network is not available, negotiating the healthcare claim to reduce the amount of the healthcare claim.

40. The method of claim 39, further comprising the integrated benefits manager charging a fee for the claim repricing process.

41. The method of claim 40, wherein the fee comprises a percentage of an amount by which the amount of the healthcare claim was reduced by performing the claim repricing process.

42. The method of claim 27, wherein the healthcare data comprises historical healthcare data and the step of analyzing the healthcare data comprises performing a predictive healthcare analysis on the historical healthcare data.

43. The method of claim 42, further comprising the integrated business management organization charging a fee for performing the predictive healthcare analysis.

44. The method of claim 43, wherein the fee is charged for each predictive healthcare analysis performed.

45. The method of claim 42, the step of identifying a plurality of healthcare issues comprises, for each of a plurality of healthcare beneficiaries, identifying at least one condition to which the healthcare beneficiary may at least be susceptible.

46. The method of claim 45, further comprising:
providing the process as a service to an employer who is at least partially funding a healthcare program, the employer paying a stop-loss insurance carrier premiums for stop-loss insurance, and
interfacing with the stop-loss insurance carrier, the stop-loss insurance carrier adjusting the premiums based on the steps of performing the predictive healthcare analysis and, for each of a plurality of healthcare beneficiaries, identifying at least one condition to which the healthcare beneficiary may at least be susceptible.

47. The method of claim 45, the step of developing strategies to address the plurality of healthcare issues comprising developing a plurality of intervention plans to at least reduce healthcare expenses associated with the conditions.

48. The method of claim 47, the step of implementing the strategies comprises implementing the plurality of intervention plans.

49. The method of claim 48, further comprising:
providing the process as a service to an employer who is at least partially funding a healthcare program, the employer paying a stop-loss insurance carrier premiums for stop-loss insurance, and
interfacing with the stop-loss insurance carrier, the stop-loss insurance carrier adjusting the premiums based on the steps of performing the predictive healthcare analysis, identifying conditions to which the plurality of beneficiaries may be susceptible, developing a plurality of intervention plans, and implementing the plurality of intervention plans.

50. The method of claim of claim 27, wherein the healthcare data comprises historical healthcare data and the step of having the healthcare data analyzed comprises performing a treatment review of the historical healthcare data.

51. The method of claim 50, further comprising the integrated business management organization charging a fee for performing the treatment review.

52. The method of claim 51, wherein the fee is charged for each treatment review performed.

53. The method of claim 50, wherein the step of identifying a plurality of healthcare issues comprises identifying treatment deficiencies.

54. The method of claim 53, wherein the step of developing strategies to address the plurality of healthcare issues comprises preparing treatment protocols to remedy the treatment deficiencies.

55. The method of claim 54, wherein the step of implementing the strategies comprises implementing the treatment protocols.

56. The method of claim 55, further comprising:
providing the process as a service to an employer who is at least partially funding a healthcare program, the employer paying a stop-loss insurance carrier premiums for stop-loss insurance, and
interfacing with the stop-loss insurance carrier, the stop-loss insurance carrier adjusting the premiums based on the steps of performing the treatment review, identifying treatment deficiencies, preparing a treatment protocols, and implementing the treatment protocols.

57. The method of claim 27, wherein the integrated benefits management organization provides the process on a fee-for-service basis.

58. The method of claim 27, wherein the integrated benefits management organization is not in the business of providing healthcare insurance.

59. The method of claim 27, further comprising providing the process to an employer who is at least partially self-insured.
